(19) United States
(12) Patent Application Publication
(10) Pub. No.: US 2025/0318517 A1
(43) Pub. Date: Oct. 16, 2025

(54) KEEL FOR A BIRD DECOY

(71) Applicant: Warren Nicholas Smith, Palmerston North (NZ)

(72) Inventor: Warren Nicholas Smith, Palmerston North (NZ)

(21) Appl. No.: 19/054,701

(22) Filed: Feb. 14, 2025

(30) Foreign Application Priority Data
Feb. 15, 2024 (AU) 2024900358

(51) Int. Cl. A01M 31/06

(52) U.S. Cl. CPC A01M 31/06

(57) ABSTRACT

The present disclosure generally relates to a keel for a bird decoy. In one embodiment, a keel includes a keel body with a leading edge, a trailing edge, an upper portion and a lower portion. A pair of fins extend outwardly from the lower portion of the keel body in generally opposite directions. The keel also includes an attachment feature adapted to receive a tether line, and the attachment feature is located near the leading edge of the keel body.

### FIELD OF THE INVENTION

This invention relates to a keel for a bird decoy.

### BACKGROUND

Game bird hunting is both a recreational sport and a way to harvest wild animals for food. As wild animals, game birds can be wary of both humans and foreign objects. Hunters have developed numerous techniques throughout history to attract games birds to locations where hunters can successfully shoot the birds. For example, for water fowl, it is common for hunters to place one or more decoys on a water surface, such as a lake or estuary. The decoys are buoyant devices having the shape and colour of the games birds that are being hunted. The decoys can either be tied together or have anchors for maintaining the decoys in place on the water surface.

The theory is that the birds will believe the decoys to be real birds, consider the location is a good, safe location and be attracted towards the location. While the decoys have the colour and the shape of real birds, a common problem is that the decoys typically do not move in a manner similar to real birds. As such, the birds being hunted can realise the decoys are not birds, but are foreign objects, and fly away.

It is an object of at least preferred embodiments of the present invention to solve the problem above, and/or to at least provide the public with a useful alternative.

### SUMMARY OF THE INVENTION

In a first aspect there is provided a keel for a bird decoy, the keel comprising: a. a keel body, the keel body having a leading edge and a trailing edge, an upper portion and a lower portion; b. a pair of fins extending outwardly from the lower portion of the keel body in generally opposite directions; and c. an attachment feature adapted to receive a tether line, the attachment feature being located near the leading edge of the keel body.

In one embodiment, the keel further comprises a bulb at or near a lower end of the lower portion of the keel body, the pair of fins extending outwardly from the bulb.

In one embodiment, the bulb has a nose extending beyond the leading edge of the keel body in a longitudinal direction.

In one embodiment, the bulb has a tail extending beyond the trailing edge of the keel body in a longitudinal direction.

In one embodiment, the keel body has a length, each fin has a length that is generally the same as the length of the keel body.

In one embodiment, the keel fins extend perpendicularly outwardly from the lower portion of the keel body.

In one embodiment, the keel attachment feature is an aperture.

In one embodiment, the keel attachment feature is located in the lower portion of the keel body.

In one embodiment, the keel further comprises one or more tether storage features.

In one embodiment, the keel further comprises a connection feature extending upwardly from the upper portion of the keel body, the connection feature adapted to connect with a corresponding connection feature of the bird decoy.

In one embodiment, the keel further comprises a flange at or near the top of the body, and wherein the connection feature extends upwardly from the flange.

In one embodiment, the connection feature is or comprises a clip.

In one embodiment, the clip has a body and a locking mechanism.

In one embodiment, the body of the clip extends upwardly from the flange and is configured to fit through an aperture of the decoy.

In one embodiment, the body has a pair of opposing flexible arms, each arm having outwardly projecting barbs.

In one embodiment, the keel is or comprises a polymeric material.

In one embodiment, the clips are integral with the flange and/or other features of the keel.

In one embodiment, the connection feature comprises two or more clips.

In one embodiment, there is provided a combination of the keel as described above together with a tether attached to the keel via the attachment feature.

In one embodiment, there is provided a combination of a bird decoy and the keel as described above.

In another aspect there is provided a keel for a bird decoy, the keel comprising: a. a keel body, the keel body having an upper portion and a lower portion; and b. a connection feature extending upwardly from the upper portion of the keel body, the connection feature adapted to connect with a corresponding connection feature of the bird decoy.

In one embodiment, the keel further comprises a flange at or near the top of the body, and wherein the connection feature extends upwardly from the flange.

In one embodiment, the connection feature is or comprises a clip.

In one embodiment, the clip has a body and a locking mechanism.

In one embodiment, the body of the clip extends upwardly from the flange and is configured to fit through an aperture of the decoy.

In one embodiment, the body has a pair of opposing flexible arms, each arm having outwardly projecting barbs.

In one embodiment, the keel is or comprises a polymeric material.

In one embodiment, the clips are integral with the flange and/or other features of the keel.

In one embodiment, the connection feature comprises two or more clips.

In one embodiment, there is provided the combination of a bird decoy and the keel as described above.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 is a perspective view of a decoy together with one embodiment of a keel.

FIG. 2 is a perspective view of the decoy, together with the keel of FIG. 1 and a tether and weight as in a stored position.

FIG. 3 is a side view of the decoy and keel of FIG. 1 in use, with a partial cross section showing the attachment between the keel and the decoy.

FIG. 4 is side view of the decoy of FIG. 1 in use, with an additional tether and weight.

FIG. 5 is a perspective view of the keel of FIG. 1.

FIG. 6 is a top view of the keel of FIG. 5.

FIG. 7 is a side view of the keel of FIG. 5.

FIG. 8 is a front view of the keel of FIG. 5.

FIG. 9 is a rear view of the keel of FIG. 5.

FIG. 10 is a cross section through line A-A of FIG. 7.

FIG. 11 is a perspective view of another embodiment of the keel.

FIG. 12 is a top view of the keel of FIG. 11.

FIG. 13 is a side view of the keel of FIG. 11.

FIG. 14 is a front view of the keel of FIG. 11.

FIG. 15 is a rear view of the keel of FIG. 11.

FIG. 16 is a cross section through line B-B of FIG. 13.

FIG. 17 is a perspective view of another embodiment of the keel.

FIG. 18 is a top view of the keel of FIG. 17.

FIG. 19 is a side view of the keel of FIG. 17.

FIG. 20 is a front view of the keel of FIG. 17.

FIG. 21 is a rear view of the keel of FIG. 17.

FIG. 22 is a cross section through line C-C of FIG. 19.

### DETAILED DESCRIPTION OF A PREFERRED EMBODIMENT

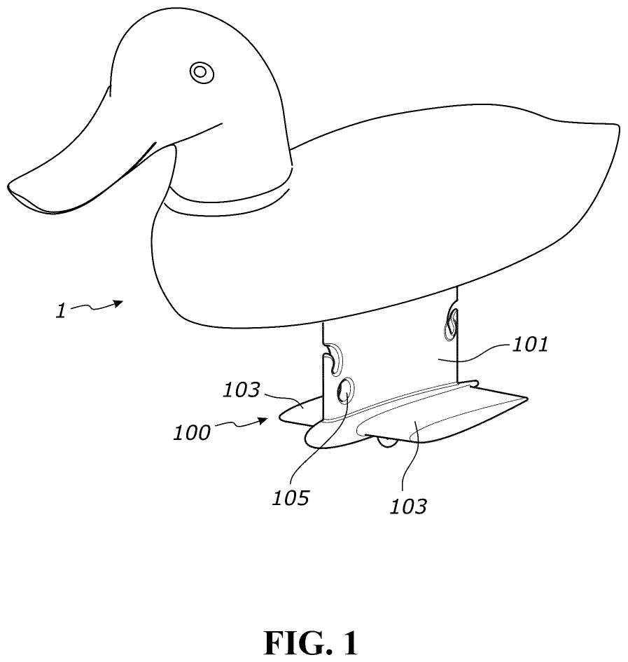

With reference to FIGS. 1 to 5, there is shown a decoy 1 together with one embodiment of a keel 100. The decoy is a buoyant device that floats atop a water surface. In use, the keel will be attached to, and extend downwardly from, the decoy 1. As such, the keel will be located under water when the decoy 1 is floating on the water. The keel 100 has a keel body 101, a pair of fins 103, and an attachment feature 105.

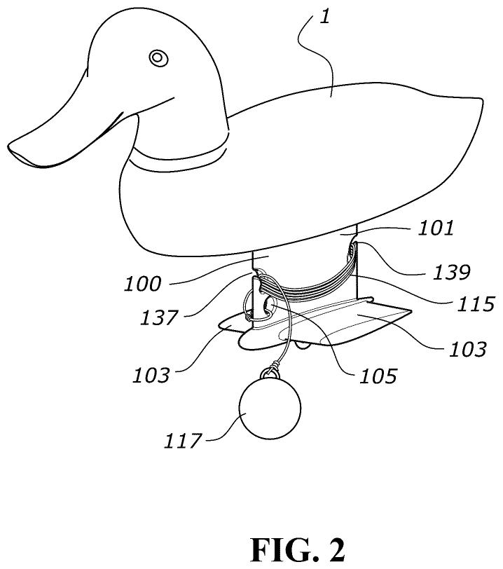

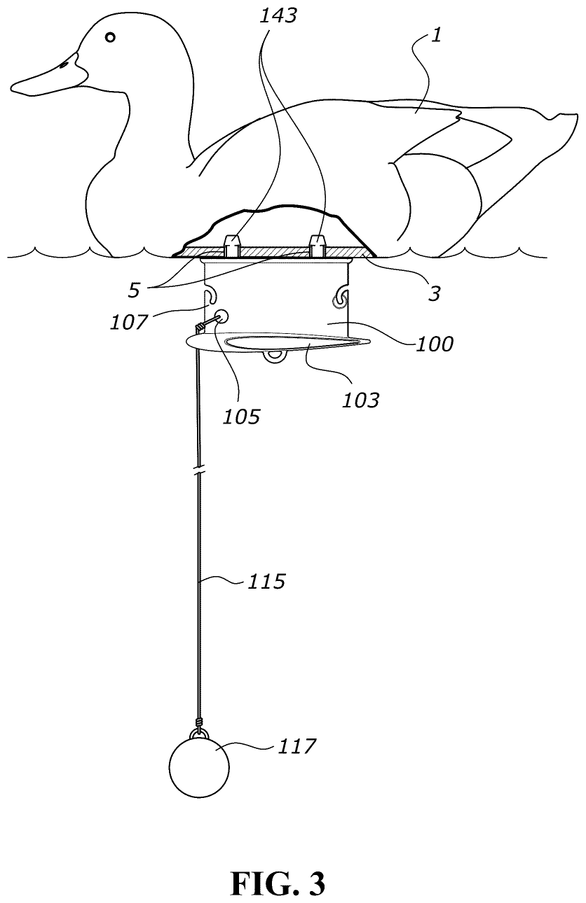

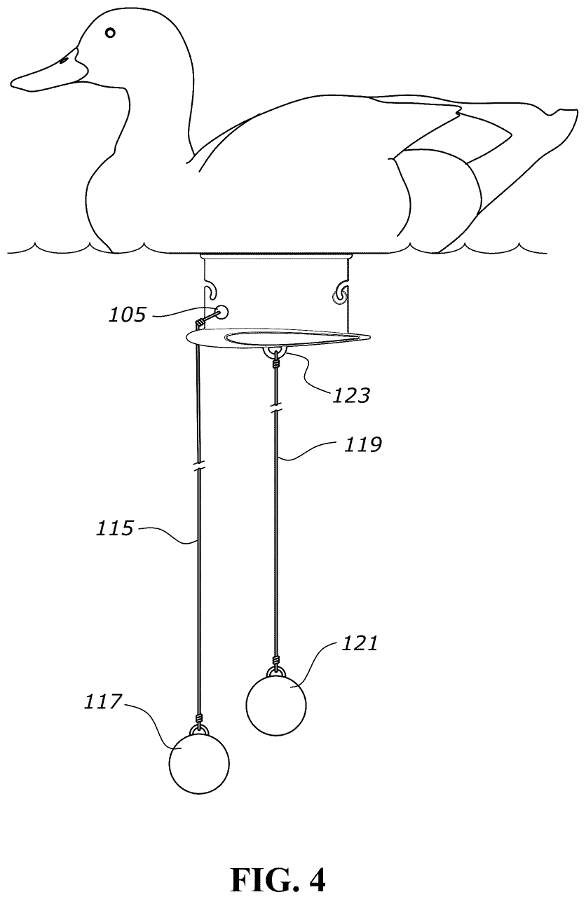

The attachment feature is adapted to receive a tether 115, which is shown in FIG. 2. The tether 115 is a line that extends between the attachment feature 105 and a weight 117. FIG. 2 shows the tether 115 wrapped around the keel body 101. This provides a useful and tidy arrangement of the tether 115 when not in use. FIG. 3 shows the decoy 1 and keel 100, together with the tether and weight in use. As shown in FIG. 3, the weight 117 is located generally below the decoy 1 in use. The weight 117 may be directly underneath or offset from the decoy 1, depending on the effect of waves and wind on the decoy 1. The weight 117 acts as an anchor for the decoy 1. FIG. 4 shows the decoy 1 with an additional tether 119 and an additional weight 121, attached to a hook 123.

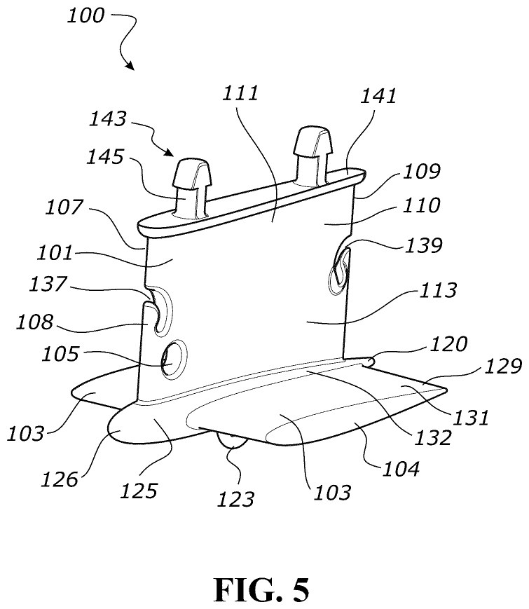

With reference to FIGS. 5 to 10, various features of the keel 100 will now be described. The keel body 101 has a leading edge 107 and a trailing edge 109. The keel body 101 also has an upper portion 111 and a lower portion 113. The keel 100 has a bulb 125 at or near a lower end of the lower portion 113 of the keel body 101.

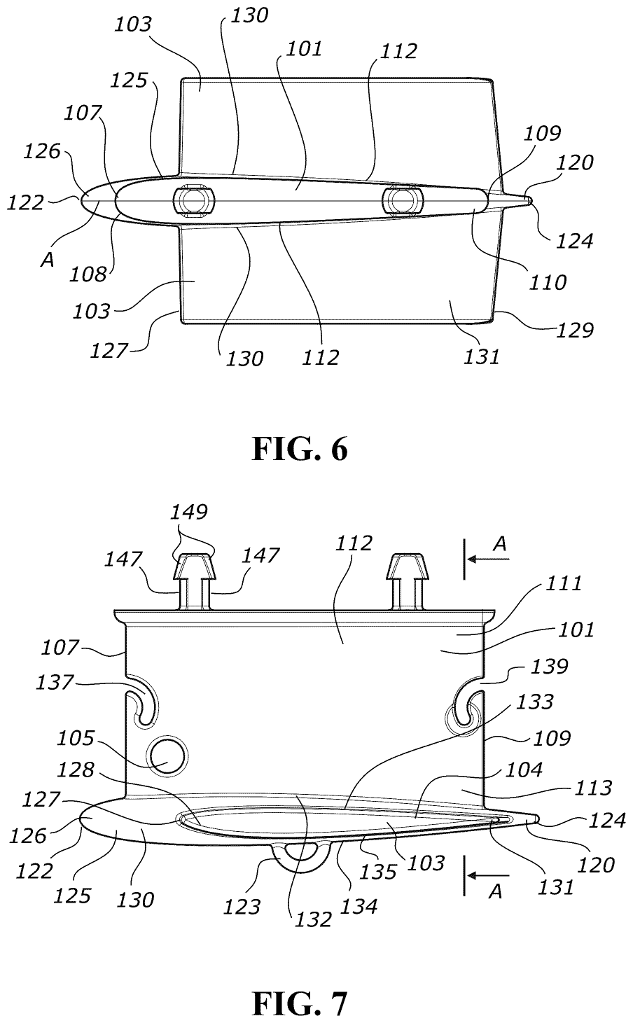

With reference to the plan view shown in FIG. 6, the keel body 101 has a generally tear drop shape. A length of the keel body 101 is greater than a width of the keel body 101, giving the keel body 101 a slender shape when viewed from above. FIG. 6 also shows the keel 100 has a longitudinal axis A, and the keel body 101 has mirror symmetry about the longitudinal axis A when viewed from above.

FIG. 6 shows the leading edge 107 of the keel body 101 is feature of a nose 108 having an arcuate surface. The arcuate surface is semi-elliptical, when viewed from above, with a length that is greater than a width. Similarly, the trailing edge 109 of the keel body 101 is a feature of tail 110 having an arcuate surface, when viewed from above. The arcuate surface of the tail 110 is semi-elliptical with a length that is greater than a width.

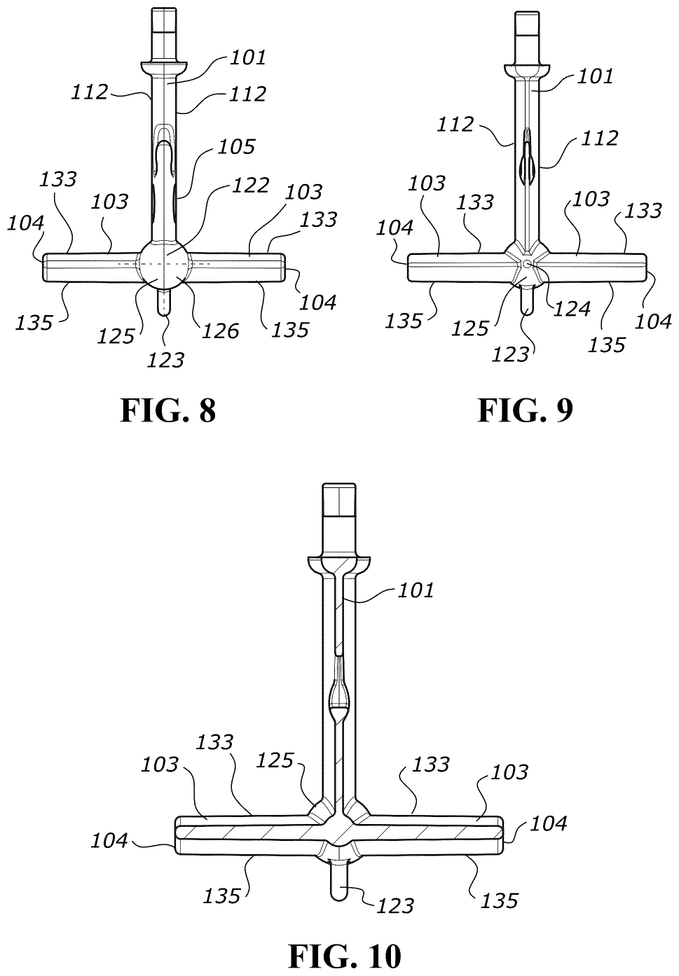

The keel body 101 has side walls 112 that taper inwardly from the nose 108 to the tail 110. The keel body 101 has smooth transitions between the nose 108, side walls 112, and the tail 110. FIGS. 8 to 10 show the side walls 112 are substantially planar. FIGS. 8 to 10 also show a height of the keel body 101 is greater than a thickness of the keel body 101, giving the keel body 101 a slender shape when viewed from the front or the rear.

With reference to the side view shown in FIG. 7, the leading edge 107 of the keel body 101 is substantially vertical. Similarly, the trailing edge 109 of the keel body 101 is substantially vertical. The keel body 101 has length that is about twice the height, when viewed from the side.

The bulb 125 has a generally tear drop shape with a length of the bulb 125 being greater than a width of the bulb 125. FIG. 6 show the bulb 125 has a slender shape when viewed from above. FIG. 7 shows the bulb 125 also has a slender shape when viewed from the side. With reference to the plan view shown in FIG. 6 the bulb 125 has mirror symmetry about the longitudinal axis A. The width of the bulb 125 is similar to the thickness of the bulb 125. FIGS. 8 to 10 show the bulb 125 has a circular cross section and is circular when viewed from the front or from the rear.

The bulb 125 has a leading edge and a trailing edge which corresponds directionally to that of the leading edge 107 and trailing edge 109 of the keel body 101. With reference to the plan view shown in FIG. 6, the leading edge 122 of the bulb 125 is a feature of a nose 126. The nose 126 has an arcuate surface. The arcuate surface of the nose 126 is semi-elliptical with a length that is greater than a width. The trailing edge 124 is a feature of a tail 120 having an arcuate surface. The arcuate surface of the tail 120 is semi-elliptical with a length that is greater than a width.

FIG. 6 shows the bulb 125 has side walls 130 that taper inwardly from the nose 126 to the tail 120. FIG. 7 shows the bulb 125 has an upper surface 132 and a lower surface 134 that that taper inwardly from the nose 126 to the tail 120. The upper and lower surfaces 132, 134 of the bulb 125 are arcuate.

The nose 126 extends beyond the leading edge 107 of the keel body 101 in a longitudinal direction. The tail 120 extends beyond the trailing edge 109 of the keel body 101 in the longitudinal direction. The bulb 125 has smooth transitions between the nose 126, side walls 130, upper and lower surfaces 132, 134, and tail 120.

As shown in FIG. 5, the pair of fins 103 extending outwardly from the bulb 125. The pair of fins 103 may extend outwardly from another lower portion of the keel body 101 in generally opposite directions, for example, if the keel 100 does not have a bulb 125.

FIG. 6 shows the keel body 101 has a length, and each fin 103 has a length that is generally the same as the length of the keel body 101. FIG. 6 shows each fin 103 has a width that is about half the length of the fin 103. Each fin 103 has a thickness that is thinner than the length or width resulting in a slender side profile, as shown in FIG. 7 and a slender front and rear profile, as shown in FIGS. 8 to 10.

With reference to the plan view shown in FIG. 6, the pair of fins 103 have mirror symmetry with each other about the longitudinal axis A of the keel 100.

As shown in FIGS. 8 to 10, the fins 103 extend perpendicularly outwardly from the bulb 125, which is at or near the lower end of the lower portion 113 of the keel body 101. The free end of each fin 103 has a substantially vertical side wall 104. The side walls 104 of each fin 103 are planar.

With reference to the side view shown in FIG. 7, each fin 103 has a leading edge 127 which corresponds directionally to that of the leading edge 107 of the keel body 101. The leading edge 127 is a feature of a nose 128 having an arcuate surface. The arcuate surface is semi-elliptical with a length that is greater than a width. The top view shown in FIG. 6 shows the leading edge 127 extends perpendicularly relative to the longitudinal axis A of the keel 100.

FIG. 7 shows the nose 128 of each fin 103 is located rearward of the attachment feature 105.

Each fin 103 also has a trailing edge 129 which corresponds directionally to that of the trailing edge 109 of the keel body 101. The trailing edge 129 is a feature of a tail 131 having an arcuate surface. The arcuate surface of the tail is semi-elliptical with a length that is similar to a width. The top view shown in FIG. 6 shows the tail 131 tapers inwardly slightly in a direction towards the nose 128 as it extends away from the bulb 125.

FIG. 7 shows the tail of each fin 103 extends beyond the tail of the keel body 101.

FIG. 7 shows each fin 103 has opposing upper 133 and lower 135 surfaces extending between the nose 128 and the tail 131. FIG. 7 shows the upper 133 and lower 135 surfaces taper outwardly and then inwardly towards each other from the nose 128 to the tail 131. The fins 103 have differently curved upper and lower surfaces. FIG. 7 shows the upper surface 133 is less curved than the lower surface 135, that is, the upper surface 133 has a greater radius of curvature than the lower surface 135. FIGS. 8 to 10 show the thickness of the upper portion of the fin 103 is less than the thickness of the lower surface of the fin 103. Alternatively, the upper and lower surfaces may have the same curvature.

Each fin 103 has smooth transitions between the nose 128, upper surface 133, tail 131, and lower surface 135.

The attachment feature 105 is located near the leading edge 107 of the keel body 101. The attachment feature 105 is an aperture. FIG. 7 shows the attachment feature 105 is located in the lower portion 113 of the keel body 101. Alternatively, the attachment feature 105 may be a recess, slot, or protrusion to which a tether may be attached.

FIGS. 2 to 4 show the tether 115 comprises a line. The line may be a polymeric material, such as nylon, or metallic, such as steel cable, or a natural fibre, such as cotton. The tether may be attached to another item, such as a weight or another decoy 1.

The keel 100 may have one or more tether storage features. FIG. 2 shows the keel body 101 has a slot 137 at the leading edge 107 and a slot 139 at the trailing edge 109 of the keel body 101. The slots 137, 139 are configured to receive the tether 115. The slots 137, 139 allow the tether 115 to be wound around the keel body 101 in a tidy and relatively secure manner.

The keel 100 may have a connection mechanism configured to attach the keel 100 to the decoy 1. The decoy 1 is a hollow item having a base 3. FIG. 3 shows the base 3 is generally flat and has one or more apertures 5 configured to receiving the connection mechanism of the keel 100. FIG. 5 shows the keel 101 has a flange 141 at the top of the keel body 101 and two or more clips 143, one of which will be described below. It will be appreciated that both clips 143 have the same features and functions.

The clip 143 has a body 145 that extends upwardly from the flange 141 and is configured to fit through the aperture 5 of the decoy 1. The body's 145 length and diameter are similar to the thickness of the base of the decoy 1 and the diameter of the aperture 5, ensuring a snug fit. The body 145 may be straight or tapered.

The body 145 has a pair of opposing flexible arms 147, each arm 147 having outwardly projecting barbs 149. When the clip 143 is inserted into the aperture 5 of the decoy 1, these arms 147 flex inwardly, allowing the clip 143 to slide through the aperture 5. Once fully inserted, the arms 147 expand or lock outwardly, securing the keel 100 to the decoy 1. This mechanism prevents the keel 100 from being removed easily from the decoy 1 and ensures a secure one-way installation.

The entire keel 100 may be made of a polymeric material. The polymeric material is resistant to corrosion and weather conditions. This ensures the keel 100 can maintain its integrity and functionality under various environmental conditions. In addition, the clips 143 are integral with the other features of the keel 100. A polymeric material will provide flexibility to the arms 147 in combination with the relatively slender dimensions and shape of the arms 147.

The embodiments shown in the accompanying drawings are a type of one way clip 143 that can not be readily removed. However, the clips 143 may have a release mechanism, such as a small tab or part of the clip that allows the clips mechanism to disengage, enabling the keel to be removed from the decoy without damage. This feature is particularly useful in applications where disassembly may be necessary for maintenance or repair.

The decoy 1 together with the keel 100 can be placed on a water surface in a location chosen to attract birds. At some stage during the process, the tether 115 will be unwound from the storage location and be allowed to suspend from the keel body 101. This acts as an anchor to maintain the decoy 1 in a relatively stable position, so the decoy does not float away.

The location of the attachment feature 105 at or near the leading edge of the keel 100 encourages the decoy 1 to pivot such that the leading edge 107 of the keel 100, and therefore the front of the decoy 1, faces into the wind and/or direction of water movement. This position is similar to the position that a real bird would take if they were in the water.

When the decoy 1 with keel 100 is in the water and anchored, features of the keel 100 impact the decoy 1 in several ways related to stability and the decoy's behaviour in response to wind, current, and waves.

The bulb 125 at the bottom of the keel 100 lowers the decoy's center of gravity. This increased ballast stability helps the decoy 1 resist rolling and pitching caused by waves or wind, making the decoy 1 more stable and closer resemble the movement of a real bird.

The fins 103 on the keel 100 can act to dampen the rolling motion of the decoy 1. When waves hit the decoy 1 from the side, the increased lateral resistance provided by the fins 103 can help reduce the amplitude of the roll, leading to a more stable decoy 1.

The keel 100 helps the decoy 1 maintain a position that minimizes movement and provides a stable platform, potentially facing into waves or wind in a manner that closer resemble the orientation of a real bird.

The hydrodynamic shape of the various parts of the keel, help dampen the motion induced by waves. The teardrop shapes allows water to flow smoothly around the keel, reducing the abruptness of movements caused by wave action. Again, that provides a movement that closer resemble the orientation of a real bird.

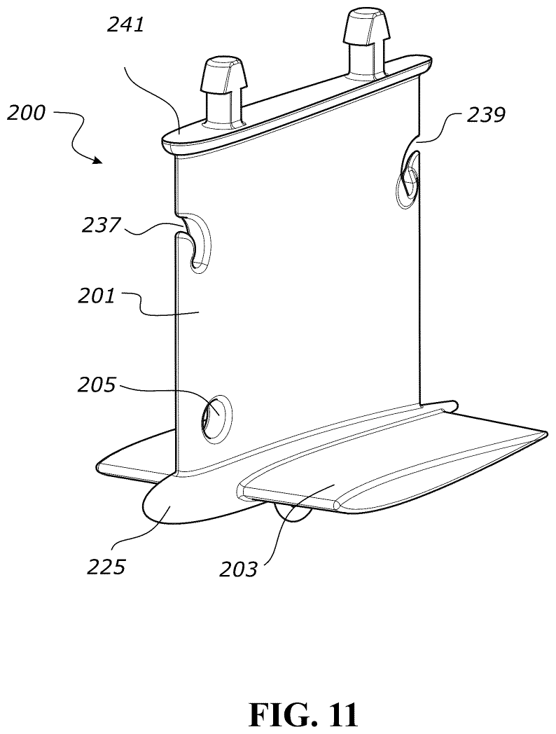

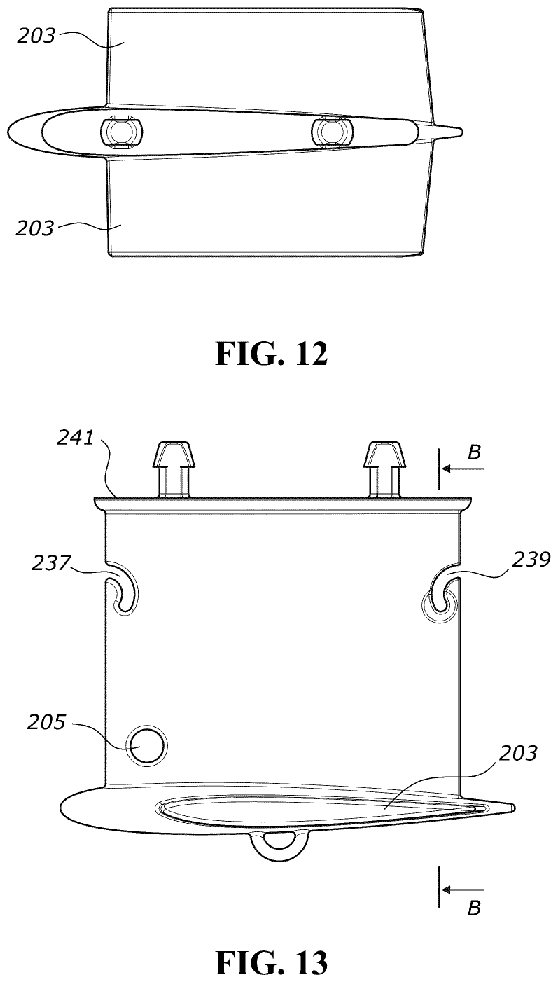

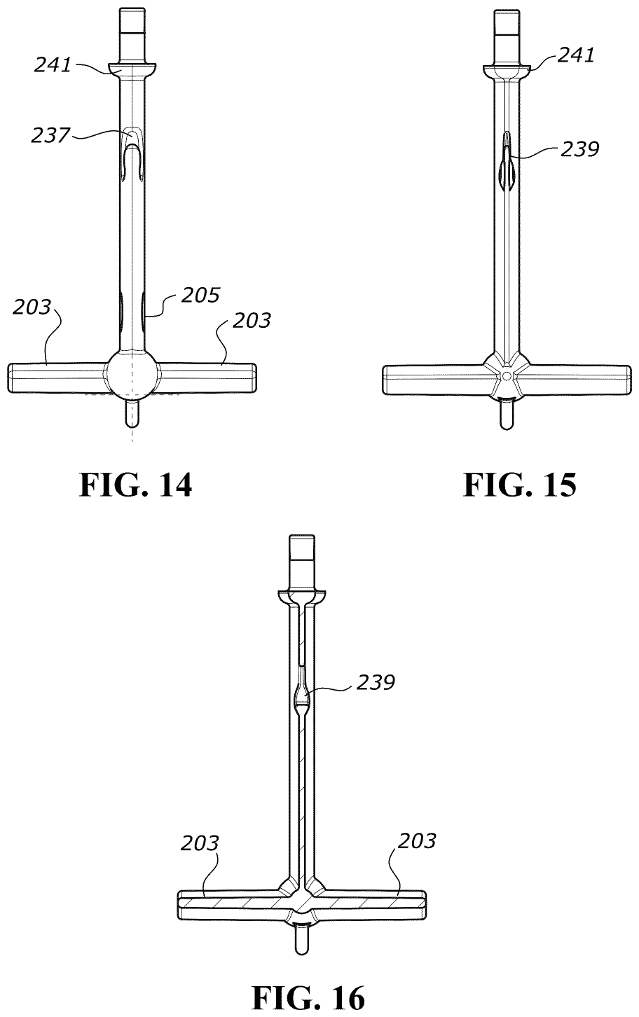

FIGS. 11 to 16 show views of another embodiment of the keel 200. The features and functionality of this embodiment are the same as the features and functionality of the embodiment shown and described in relations to FIGS. 1 to 10. Like numbers are used to indicate like parts, using 2xx in place of 1xx. The exception is that the keel body 201 of this embodiment shown in FIGS. 11 to 16 is longer than the keel body 101 of the embodiment shown and described in relations to FIGS. 1 to 10. This difference is most clearly shown in FIG. 13. It can be seen that the keel body 201 has a length and a height that are similar dimensions. The location of the attachment feature 205 remains in a similar position relative to the bulb 225 and fins 203 as those of the embodiment shown and described in relations to FIGS. 1 to 10. The location of the slots 237 and 239 remains in a similar position relative to the flange 241 as those of the embodiment shown and described in relations to FIGS. 1 to 10.

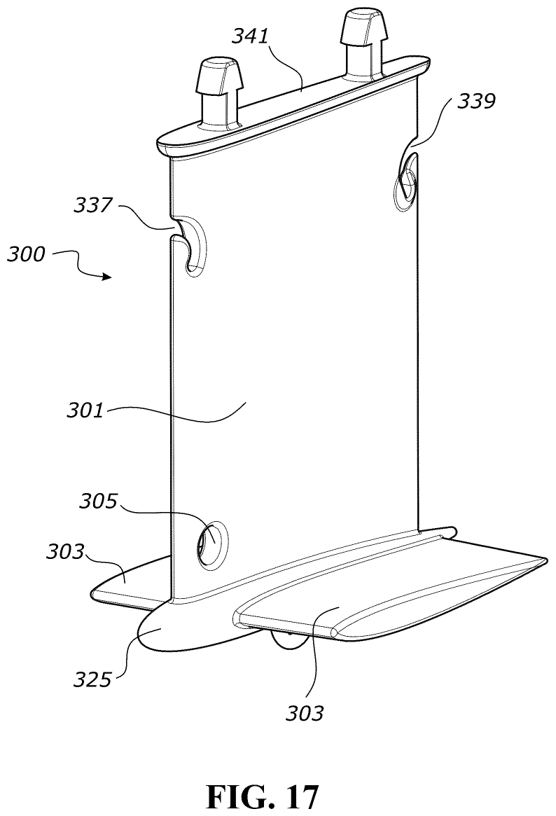

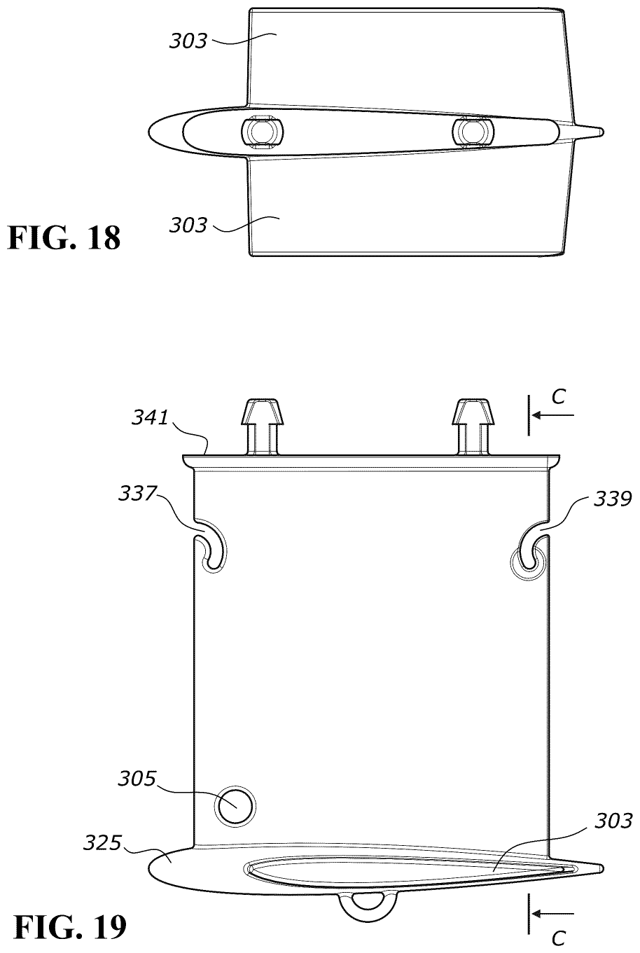

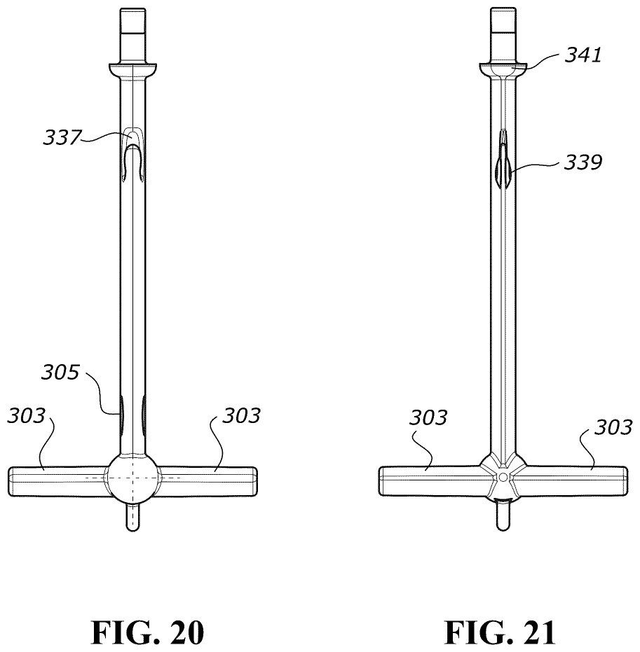

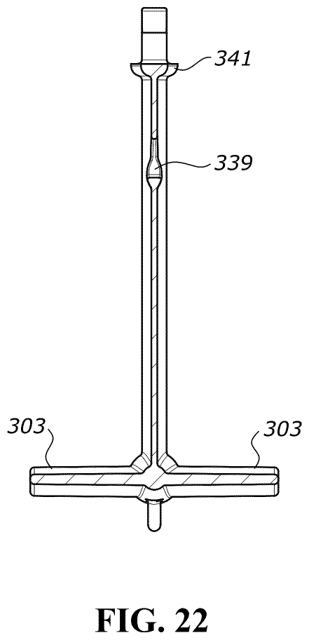

FIG. 17 to 22 show views of a further embodiment of the keel. The features and functionality of this embodiment are the same as the features and functionality of the embodiment shown and described in relations to FIGS. 1 to 10 and the embodiment shown and described in relations to FIGS. 11 to 16. Like numbers are used to indicate like parts, using 3xx in place of 2xx or 1xx. The exception is that the keel body 301 of this embodiment shown in FIGS. 17 to 20 is longer than the keel body 101 of the embodiment shown and described in relations to FIGS. 1 to 10, and also longer than the keel body 201 of the embodiment shown and described in relations to FIGS. 11 to 16. This difference is most clearly shown in FIG. 19. It can be seen that the keel body 301 has a height and a length, with the height being greater than the length. The location of the attachment feature 305 remains in a similar position relative to the bulb 325 and fins 303 as those of the embodiment shown and described in relations to FIGS. 1 to 10. The location of the slots 337 and 339 remains in a similar position relative to the flange 341 as those of the embodiment shown and described in relations to FIGS. 1 to 10.

Preferred embodiments of the invention have been described by way of example only and modifications may be made thereto without departing from the scope of the invention.

1. A keel for a bird decoy, the keel comprising:
a. a keel body, the keel body having a leading edge and a trailing edge, an upper portion and a lower portion;
b. a pair of fins extending outwardly from the lower portion of the keel body in generally opposite directions; and
c. an attachment feature adapted to receive a tether line, the attachment feature being located near the leading edge of the keel body.

2. The keel of claim 1, further comprising a bulb at or near a lower end of the lower portion of the keel body, the pair of fins extending outwardly from the bulb.

3. The keel of claim 2, wherein the bulb has a nose extending beyond the leading edge of the keel body in a longitudinal direction.

4. The keel of claim 3, wherein the bulb has a tail extending beyond the trailing edge of the keel body in a longitudinal direction.

5. The keel of claim 1, wherein the keel body has a length, each fin has a length that is generally the same as the length of the keel body.

6. The keel of claim 1, wherein the keel fins extend perpendicularly outwardly from the lower portion of the keel body.

7. The keel of claim 1, wherein the keel attachment feature is an aperture.

8. The keel of claim 1, wherein the keel attachment feature is located in the lower portion of the keel body.

9. The keel of claim 1, further comprising one or more tether storage features.

10. The keel of claim 1, further comprising:
a connection feature extending upwardly from the upper portion of the keel body, the connection feature adapted to connect with a corresponding connection feature of the bird decoy.

11. The keel of claim 10, further comprising a flange at or near the top of the body, and wherein the connection feature extends upwardly from the flange.

12. The keel of claim 11, wherein the connection feature is or comprises a clip.

13. The keel of claim 12, wherein the clip has a body and a locking mechanism.

14. The keel of claim 13, wherein the body of the clip extends upwardly from the flange and is configured to fit through an aperture of the decoy.

15. The keel of claim 13, wherein the body has a pair of opposing flexible arms, each arm having outwardly projecting barbs.

16. The keel of claim 12, wherein the clips are integral with the flange.

17. The keel of claim 10, wherein the connection feature comprises two or more clips.

18. The keel of claim 1, wherein the keel is or comprises a polymeric material.

19. A combination of a keel as claimed in claim 1 together with a tether attached to the keel via the attachment feature.

20. A combination of a bird decoy and a keel as claimed in claim 1.
